(19) United States
(12) Patent Application Publication
(10) Pub. No.: US 2025/0221341 A1
(43) Pub. Date: Jul. 10, 2025

(54) Tree Shaking Device

(71) Applicant: Timothy Crawford, Golden, CO (US)

(72) Inventor: Timothy Crawford, Golden, CO (US)

(21) Appl. No.: 18/409,777

(22) Filed: Jan. 10, 2024

(51) Int. Cl. A01D 46/26

(52) U.S. Cl. CPC A01D 46/26

(57) ABSTRACT

A tree shaking device includes an engagement member having a first portion having a first concave region and adjacent second portion having a second concave region. The tree shaking device also includes a coupling portion located between the first portion and the second portion and configured to couple to a pole.

### BACKGROUND

Trees experiencing weight stress may lose branches or even fall over. For example, snow accumulating on branches or leaves may cause the branches or the whole tree to break. Reaching high branches to shake the snow from the branches can be difficult. For example, poles and other devices used to shake the branches may be not properly engage the branches.

### SUMMARY

In a first embodiment, a tree shaking device is provided. The tree shaking device includes: an engagement member having a first portion having a first concave region and adjacent second portion having a second concave region; and a coupling portion located between the first portion and the second portion and configured to couple to a pole.

In another embodiment, a tree shaking device is provided. The tree shaking device includes: an engagement member having a first portion having a first concave region and adjacent second portion having a second concave region; and a coupling portion located opposite the first concave region, the coupling portion being at least partially threaded and configured to screw onto a pole via threads, wherein the first concave region opens in a direction and wherein the coupling portion is configured to attach to the pole extending in the direction, and wherein the engagement member is at least partially S-shaped when viewed from a side.

In yet another embodiment, a tree shaking device is provided. The tree shaking device includes: an engagement member having a first portion having a first concave region of a first radius and adjacent second portion having a second concave region of a second radius, wherein the first radius is greater than the second radius; and a coupling portion located opposite the first concave region, the coupling portion being at least partially threaded and configured to screw onto a pole via threads, wherein the first concave region opens in a direction and wherein the coupling portion is configured to attach to the pole extending in the direction, wherein the engagement member is at least partially S-shaped when viewed from a side, and wherein the engagement member has a first end proximate the first portion and wherein the first end is at least partially beveled.

### BRIEF DESCRIPTION OF DRAWINGS

The drawings described below are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1A illustrates a rear isometric view of a tree shaking device according to embodiments provided herein.

FIG. 1B illustrates a front isometric view of the tree shaking device of FIG. 1 according to embodiments provided herein.

FIG. 2 illustrates a tree shaking device wherein a first concave portion is contacting a branch of a tree according to embodiments provided herein.

FIG. 3 illustrates a tree shaking device wherein a second concave portion is contacting a branch of a tree according to embodiments provided herein.

FIG. 4 illustrates a side elevation view of an embodiment of a tree shaking device according to embodiments provided herein.

FIG. 5 illustrates a top plan view of the tree shaking device of FIG. 4 according to embodiments provided herein.

### DETAILED DESCRIPTION

In accordance with one or more embodiments provided herein, tree shaking devices for shaking tree branches and whole trees are disclosed. Embodiments of the tree shaking device may include an engagement member having concave regions located at opposite ends. A first portion of the engagement member may have a first concave region that opens to a first direction. A second portion of the engagement member may have a second concave region that opens in an opposite direction relative to the direction that the first concave region opens. Accordingly, when viewed from a side, the engagement member may be at least partially S-shaped. In some embodiments, the first concave region may have a first radius, the second concave region may have a second radius, and the first radius may be greater than the second radius.

A coupling portion may be attached to the engagement member and may be configured to couple the tree shaking device to a pole or the like. The attachment to the pole enables a user to reach the tree shaking device to high branches in a tree (branches as used herein also include trunk portions and other portions of a tree). One of the concave regions may then be used to contact the tree or branch to pull or push the branch, which shakes debris from the branch. The debris may include snow, fruit, nuts, lights, and other items. A shaking machine may be attached to the pole, which shakes the pole and thus the tree shaking device. The use of the shaking machine enables automated shaking of the branch. Examples of the shaking machine include reciprocating saws and other reciprocating devices coupled to the tree shaking device. These and other embodiments are described with reference to the drawings.

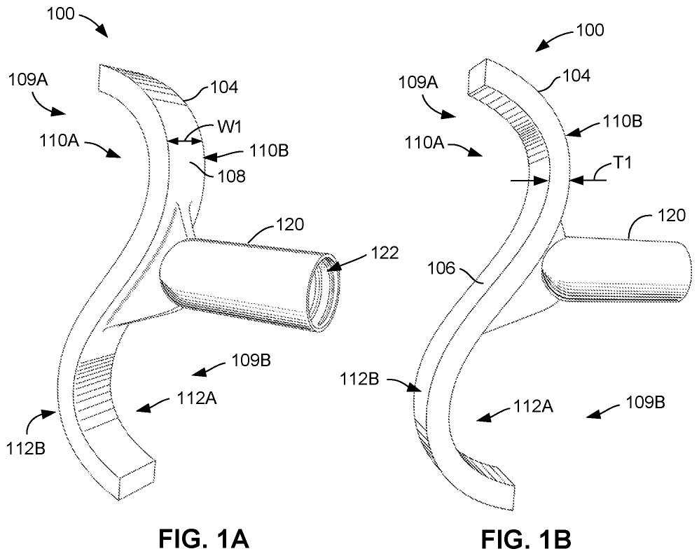

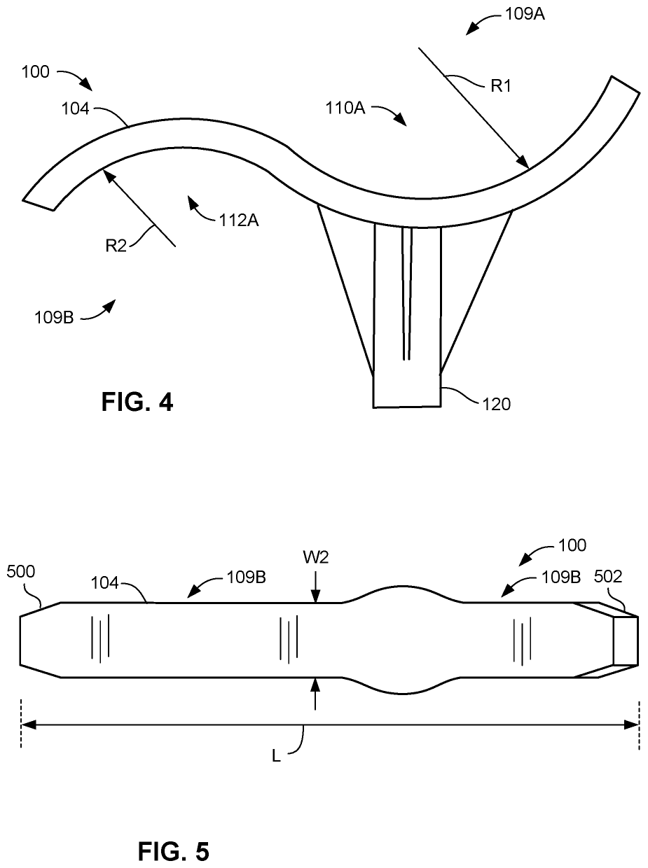

Reference is made to FIGS. 1A, which illustrates a rear isometric view of a tree shaking device 100 and 1B. FIG. 1A, which illustrates a front isometric view of the tree shaking device 100 according to one or more embodiments. The tree shaking device 100 may include an engagement member 104 that may be at least partially S-shaped when viewed from a side, such as by the side elevation view of FIG. 4. The engagement member 104 may include a front surface 106 and a rear surface 108. The engagement member 104 may have a width W1. The width W1 may be wide enough to engage a branch or a tree without damaging bark on the tree as described herein. Portions of the front surface 106 and/or the rear surface 108 may include a material that prevents the front surface 106 and/or the rear surface 108 from damaging bark on the tree. For example, portions of the front surface 106 and/or the rear surface 108 may include an elastic material, such a rubber or the like.

The engagement member 104 may include a first portion 109A adjacent a second portion 109B. The combination of the first portion 109A and the second portion 109B may for the S-shape of the engagement member 104 as described herein. The first portion 109A may include a first concave region 110A in the front surface 106 with an opposite first convex region 110B in the rear surface 108. The engagement member 104 may also include a second concave region 112A in the rear surface 108 with an opposite second convex region 112B in the front surface 106. A radius or curvature of the first concave region 110A may be different than a radius of the second concave region 112A. For example, the first concave region 110A may have a greater radius than the radius of the second concave region 112A. The differences in radii may enable the first concave region 110A and the second concave region 112A to contact different radii of tree branches.

A coupling portion 120 may be coupled to the engagement member 104, such as to the rear surface 108. In some embodiments, the coupling portion 120 may be affixed between the first portion 109A and the second portion 109B of the engagement member 104. In other embodiments, such as the embodiment of FIG. 4 the coupling portion 120 may be attached to the engagement member 104 opposite the first concave region 110A. The coupling portion 120 is configured to enable the tree shaking device 100 to be coupled to a pole (not shown). The coupling portion 120 may include a hole 122 configured to receive the pole. In some embodiments, the hole 122 may be threaded to receive a threaded pole. Other embodiments of the coupling portion 120 may include devices (not shown) that are configured to couple the tree shaking device 100 to the pole. The pole enables a user to position the tree shaking device 100 against a branch. The user may then shake the branch by pulling and/or pushing on the pole. In some embodiments, the user may attach the pole to a shaking machine, such as a reciprocating saw, that causes the tree shaking device 100 and, thus, the branch to shake (e.g., vibrate). The vibration frees debris, such as snow, from the branch.

In some embodiments, the coupling portion 120 may be configured to extend in a direction opposite the opening of the first radius R1 (FIG. 4). For example, the hole 122 or a pole received in the hole 122 may extend in a first direction and the first concave region 110A may open in a second direction that is opposite the first direction.

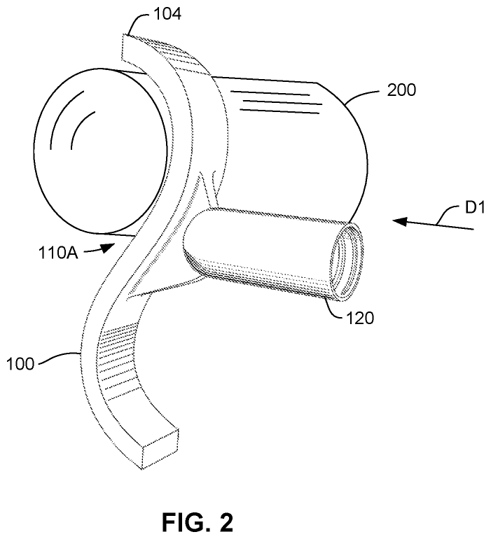

Additional reference is made to FIG. 2, which illustrates the tree shaking device 100 contacting and shaking a branch 200. In the embodiment of FIG. 2, the branch 200 is received in the first concave region 110A and a force is applied in a direction D1 to shake the branch 200. The above-described tree shaking device 100 may shake the branch 200 along an axis defining the direction D1.

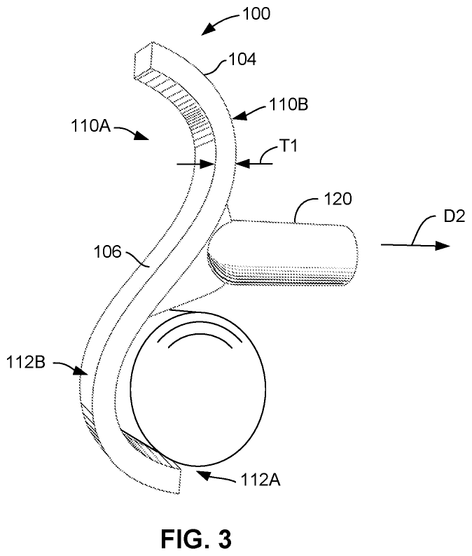

Additional reference is made to FIG. 3, which illustrates the tree shaking device 100 contacting and shaking a branch 300. In the embodiment of FIG. 3, the branch 300 is received in the second concave region 112A and a force is applied in a direction D2 to shake the branch 300. The direction D2 may be opposite the direction D1. The above-described shaking device may shake the branch 300 along an axis defining the direction D2.

Additional reference is made to FIGS. 4 and 5, which illustrate different embodiments of the tree shaking device 100. FIG. 4 is an elevation view of the tree shaking device 100 and FIG. 5 is a top plan view of the tree shaking device 100. In the embodiment of FIGS. 4 and 5, the coupling portion 120 may be attached to the engagement member 104 opposite the first concave region 110A. Such an attachment may provide structural integrity as the tree shaking device 100 pushes against a branch as shown in FIG. 2.

The first concave region 110A may have first radius R1. In some embodiments, the first radius R1 may be between two inches and four inches. In other embodiments, the first radius R1 may be about three inches. The second concave region 112A may have a second radius R2. In some embodiments, the second radius R2 may be between one and three inches. In other embodiments, the radius may be about two inches. The first radius R1 may be greater than the second radius R2, which may enable the tree shaking device 100 to better contact branches of different diameters.

The engagement member 104 may have a length L extending between a first end 500 and a second end 502. The length L may be between eight and ten inches. In other embodiments, the length L may be about nine inches. The length L enables the tree shaking device 100 to be fit between branches to contact a specific branch. One or both of the first end 500 and the second end 502 may be beveled as shown in FIG. 5. The beveling may enable the tree shaking device 100 to be placed between branches in a tree without getting caught on a branch.

In some embodiments, the engagement member 104 may have a constant width, such as the width W1 shown in FIG. 1. In the embodiment shown in FIG. 5, the width of the engagement member 104 may be wider in the location where the coupling portion 120 contacts the engagement member 104. However, the second portion 109B may have a substantially constant width W2, which may be between 0.8 inches and 1.2 inches. In other embodiments, the width W2 may be about one inch.

Referring to FIG. 1, the engagement member 104 may have a thickness T1 extending between the front surface 106 and the rear surface 108. The thickness T1 may be about 0.5 inches.

Accordingly, while the present invention has been disclosed in connection with the example embodiments thereof, it should be understood that other embodiments may fall within the spirit and scope of the invention, as defined by the following claims.

What is claimed:

1. A tree shaking device comprising:
an engagement member having a first portion having a first concave region and adjacent second portion having a second concave region; and
a coupling portion located between the first portion and the second portion and configured to couple to a pole.

2. The tree shaking device of claim 1, wherein the first concave region opens in a direction and wherein the coupling portion is configured to attach to the pole extending in the direction.

3. The tree shaking device of claim 1, wherein the coupling portion is at least partially threaded and is configured to screw onto threads of the pole.

4. The tree shaking device of claim 1, wherein at least one of the first concave region or the second concave region is configured to at least partially receive a tree branch.

5. The tree shaking device of claim 1, wherein both the first concave region and the second concave region are configured to at least partially receive a tree branch.

6. The tree shaking device of claim 1, wherein the engagement member is at least partially S-shaped when viewed from a side.

7. The tree shaking device of claim 1, wherein the engagement member has a length of between eight and ten inches.

8. The tree shaking device of claim 1, wherein the engagement member has a length of about nine inches.

9. The tree shaking device of claim 1, wherein the second concave region has a width of between 0.8 inches and 1.2 inches.

10. The tree shaking device of claim 1, wherein the second concave region has a width of about 1.0 inches.

11. The tree shaking device of claim 1, wherein the first concave region has a radius of between two inches and four inches.

12. The tree shaking device of claim 1, wherein the first concave region has a radius of about three inches.

13. The tree shaking device of claim 1, wherein the coupling portion is located opposite the first concave region.

14. The tree shaking device of claim 1, wherein the coupling portion is located adjacent the second portion.

15. The tree shaking device of claim 1, wherein the first concave region has a first radius, wherein the second concave region has a second radius, and wherein the first radius is greater than the second radius.

16. The tree shaking device of claim 1, wherein the engagement member has a first end proximate the first portion and wherein the first end is at least partially beveled.

17. The tree shaking device of claim 1, wherein the engagement member has a second end proximate the second portion and wherein the second end is at least partially beveled.

18. A tree shaking device comprising:
an engagement member having a first portion having a first concave region and adjacent second portion having a second concave region; and
a coupling portion located opposite the first concave region, the coupling portion being at least partially threaded and configured to screw onto a pole via threads,
wherein the first concave region opens in a direction and wherein the coupling portion is configured to attach to the pole extending in the direction, and
wherein the engagement member is at least partially S-shaped when viewed from a side.

19. The tree shaking device of claim 18, wherein the first concave region has a first radius, wherein the second concave region has a second radius, and wherein the first radius is greater than the second radius.

20. A tree shaking device comprising:
an engagement member having a first portion having a first concave region of a first radius and adjacent second portion having a second concave region of a second radius, wherein the first radius is greater than the second radius; and
a coupling portion located opposite the first concave region, the coupling portion being at least partially threaded and configured to screw onto a pole via threads,
wherein the first concave region opens in a direction and wherein the coupling portion is configured to attach to the pole extending in the direction,
wherein the engagement member is at least partially S-shaped when viewed from a side, and
wherein the engagement member has a first end proximate the first portion and wherein the first end is at least partially beveled.
